(19) United States
(12) Patent Application Publication
(10) Pub. No.: US 2012/0027100 A1
(43) Pub. Date: Feb. 2, 2012

(54) METHOD AND APPARATUS FOR TRANSMITTING AND RECEIVING EXTENDED BROADCAST SERVICE IN DIGITAL BROADCASTING

(75) Inventors: Sung-il PARK, Suwon-si (KR); Hae-joo JEONG, Seoul (KR)

(73) Assignee: SAMSUNG ELECTRONICS CO., LTD., Suwon-si (KR)

(21) Appl. No.: 13/194,473

(22) Filed: Jul. 29, 2011

(30) Foreign Application Priority Data
Jul. 30, 2010 (KR) 10-2010-0074383

(51) Int. Cl. H04N 7/24; H04N 7/26; H04N 7/00

(52) U.S. Cl. 375/240.26; 348/461; 348/E07.002; 375/E07.189; 375/E07.02

(57) ABSTRACT

A method and apparatus for transmitting and receiving digital broadcasting. The method includes transmitting and receiving main broadcast data and supplemental broadcast data, wherein the main broadcast data is able to independently provide a basic broadcast service and the supplemental broadcast data is able to provide an extended broadcast service in combination with the main broadcast data, by using methods that are different from each other and thus the extended broadcast service may be provided.

### CROSS-REFERENCE TO RELATED PATENT APPLICATION

This application claims priority from Korean Patent Application No. 10-2010-0074383, filed on Jul. 30, 2010, in the Korean Intellectual Property Office, the disclosure of which is incorporated herein in its entirety by reference.

### BACKGROUND

1. Field

Methods and apparatuses consistent with exemplary embodiments relate to transmitting and receiving digital broadcasting, and more particularly, to a method and apparatus for transmitting and receiving data for providing an extended broadcast service.

2. Description of the Related Art

Advanced television standards committee (ATSC) digital television (DTV) high definition (HD) service is a DTV standard for Korea and the US. Currently, in Korea, a service in one transmission frequency band, that is, an HD TV service having a resolution of 1920×1080i, is provided at a speed of 19.395 Mbps at 6 MHz. In this regard, high-quality contents may be provided to viewers; however, a large number of services including various contents may not be provided.

According to requests of users who desire to receive a large number of services, some broadcasting providers have considered adopting a multi mode service (MMS) in which an extra frequency band is secured by degrading the quality of the HD service to thereby enable the provision of additional services.

In ATSC MMS, a 1280×720p HD TV service is provided instead of a 1920×1080i HD TV service and thus additional data transmission space may be secured. In the additional data transmission space, channels such as a standard definition (SD) TV service, a data service, an ultra definition (UD) TV service, and a 3D TV (3D image) service may be added. That is, in a transmission band of 6 MHz, a plurality of services may be provided.

### SUMMARY

One or more exemplary embodiments provide a method and apparatus for transmitting and receiving data for providing an extended broadcast service.

According to an aspect of an exemplary embodiment, there is provided a method of transmitting digital broadcasting, the method including: generating main broadcast data and supplemental broadcast data, wherein the main broadcast data is able to independently provide a basic broadcast service and the supplemental broadcast data is able to provide an extended broadcast service in combination with the main broadcast data; and transmitting the main broadcast data and the supplemental broadcast data by using methods that are different from each other.

The supplemental broadcast data may include at least one from the group consisting of image quality improvement data, 3D image data, five senses data, and interactive broadcast data.

In the transmitting, the main broadcast data and the supplemental broadcast data may be transmitted through programs that are different from each other.

The transmitting may include: transmitting the main broadcast data through a transport stream (TS); and transmitting the supplemental broadcast data through an unused area of the TS.

The TS may include an MPEG-2 TS and the unused area may include a private data area of an MPEG-2 header.

In the generating of the main broadcast data and the supplemental broadcast data, the main broadcast data and the supplemental broadcast data may be generated by using encoding methods that are different from each other.

The generating of the main broadcast data and the supplemental broadcast data may include: generating the main broadcast data by using low-rate video data converted from high-rate video data; and generating the supplemental broadcast data by using differential video data representing a difference in video between the high-rate video data and the low-rate video data.

The low-rate video data and the differential video data may be generated by using encoding methods that are different from each other.

The method may further include transmitting signaling data for the supplemental broadcast data.

The signaling data may include at least one of the group consisting of information indicating the existence of the supplemental broadcast data, the type of the supplemental broadcast data, an identifier of the supplemental broadcast data, a method of generating the supplemental broadcast data, a method of transmitting the supplemental broadcast data, parameter information about the method of generating or transmitting the supplemental broadcast data, and synchronization data for synchronizing the main broadcast data with the supplemental broadcast data.

In the transmitting of the signaling data, the signaling data may be transmitted by using program specific information (PSI) or a program and system information protocol (PSIP).

The transmitting of the signaling data may include: generating the synchronization data in connection with the time of the main broadcast data; and transmitting the synchronization data by being included in an audio packet or a video packet of the supplemental broadcast data, or a series of packets.

According to another aspect of an exemplary embodiment, there is provided a method of receiving digital broadcasting, the method including: receiving main broadcast data by using a first method; determining the existence of supplemental broadcast data that is able to provide an extended broadcast service in combination with the main broadcast data; providing a basic broadcast service based on the main broadcast data when the supplemental broadcast data does not exist; and receiving the supplemental broadcast data by using a second method when the supplemental broadcast data exists and providing the extended broadcast service based on the main broadcast data and the supplemental broadcast data.

The first method and the second method may include a method of receiving data through programs that are different from each other.

In the first method, data may be received through a transport stream (TS) and in the second method, data may be received through an unused area of the TS.

The main broadcast data and the supplemental broadcast data may be generated by using encoding methods that are different from each other.

The main broadcast data may include low-rate video data representing low-quality video, the supplemental broadcast data may include differential video data representing a difference between high-quality video and the low-quality video, and the providing of the extended broadcast service may include providing the high-quality video based on the low-rate video data and the differential video data.

The method may include receiving signaling data for the supplemental broadcast data.

In the determining of the existence of the supplemental broadcast data, the existence of the supplemental broadcast data may be determined based on the signaling data.

In the providing of the extended broadcast service, the extended broadcast service may be provided by using the signaling data.

According to another aspect of an exemplary embodiment, there is provided an apparatus for transmitting digital broadcasting, the apparatus including: a generating unit which generates main broadcast data and supplemental broadcast data, wherein the main broadcast data is able to independently provide a basic broadcast service and the supplemental broadcast data is able to provide an extended broadcast service in combination with the main broadcast data; and a transmitting unit transmitting the main broadcast data and the supplemental broadcast data by using methods that are different from each other.

The transmitting unit may transmit the main broadcast data and the supplemental broadcast data through programs that are different from each other.

The transmitting unit may transmit the main broadcast data through a transport stream (TS) and the supplemental broadcast data through an unused area of the TS.

The generating unit may generate the main broadcast data and the supplemental broadcast data by using encoding methods that are different from each other.

The generating unit may generate the main broadcast data by using low-rate video data converted from high-rate video data and the supplemental broadcast data by using differential video data representing a difference in video between the high-rate video data and the low-rate video data.

According to another aspect of an exemplary embodiment, there is provided an apparatus for receiving digital broadcasting, the apparatus including: a receiving unit which receives main broadcast data by using a first method, determining the existence of supplemental broadcast data that is able to provide an extended broadcast service in combination with the main broadcast data, and receiving the supplemental broadcast data by using a second method when the supplemental broadcast data exists; and a providing unit which provides a basic broadcast service based on the main broadcast data when the supplemental broadcast data does not exist and which provides the extended broadcast service based on the main broadcast data and the supplemental broadcast data when the supplemental broadcast data exists.

The first method and the second method may include a method of receiving data through programs that are different from each other.

In the first method, data may be received through a transport stream (TS) and in the second method, data may be received through an unused area of the TS.

The main broadcast data and the supplemental broadcast data may be generated by using encoding methods that are different from each other.

The main broadcast data may include low-rate video data representing low-quality video, the supplemental broadcast data comprises differential video data representing a difference between high-quality video and the low-quality video, and the providing unit provides the high-quality video based on the low-rate video data and the differential video data.

According to another aspect of an exemplary embodiment, there is provided a non-transitory computer readable recording medium having embodied thereon a computer program for executing the method of transmitting digital broadcasting.

According to another aspect of an exemplary embodiment, there is provided a non-transitory computer readable recording medium having embodied thereon a computer program for executing the method of receiving digital broadcasting.

### BRIEF DESCRIPTION OF THE DRAWINGS

The above and/or other features and advantages of the present disclosure will become more apparent by describing in detail exemplary embodiments thereof with reference to the attached drawings in which:

FIG. 1 is a block diagram of an apparatus for transmitting digital broadcasting according to an embodiment;

FIG. 2 is a block diagram of an apparatus for receiving digital broadcasting according to an embodiment;

FIG. 3 illustrates an apparatus for receiving digital broadcasting for providing an extended broadcast service according to an embodiment;

FIG. 4 is a block diagram illustrating a method of generating image quality improvement data for a high-quality TV service according to an embodiment;

FIG. 5 is a block diagram illustrating a method of providing a high-quality TV service according to an embodiment;

FIG. 6 is a block diagram illustrating a method of generating image quality improvement data for a high-quality TV service according to another embodiment;

FIG. 7 is a block diagram illustrating a method of providing a high-quality TV service according to another embodiment;

FIG. 8 illustrates an apparatus for transmitting digital broadcasting according to an embodiment;

FIG. 9 illustrates an apparatus for receiving digital broadcasting according to an embodiment;

FIG. 10 is a flowchart illustrating a method of transmitting digital broadcasting according to an embodiment; and

FIG. 11 is a flowchart illustrating a method of receiving digital broadcasting according to an embodiment.

### DETAILED DESCRIPTION

Hereinafter, certain exemplary embodiments will be described more fully with reference to the accompanying drawings. In the description, detailed descriptions of well-known technologies and structures may be omitted so as not to hinder clear understanding of the exemplary embodiments. In the drawings, like reference numerals denote like elements. For convenience of description, an apparatus and a method are described at the same time.

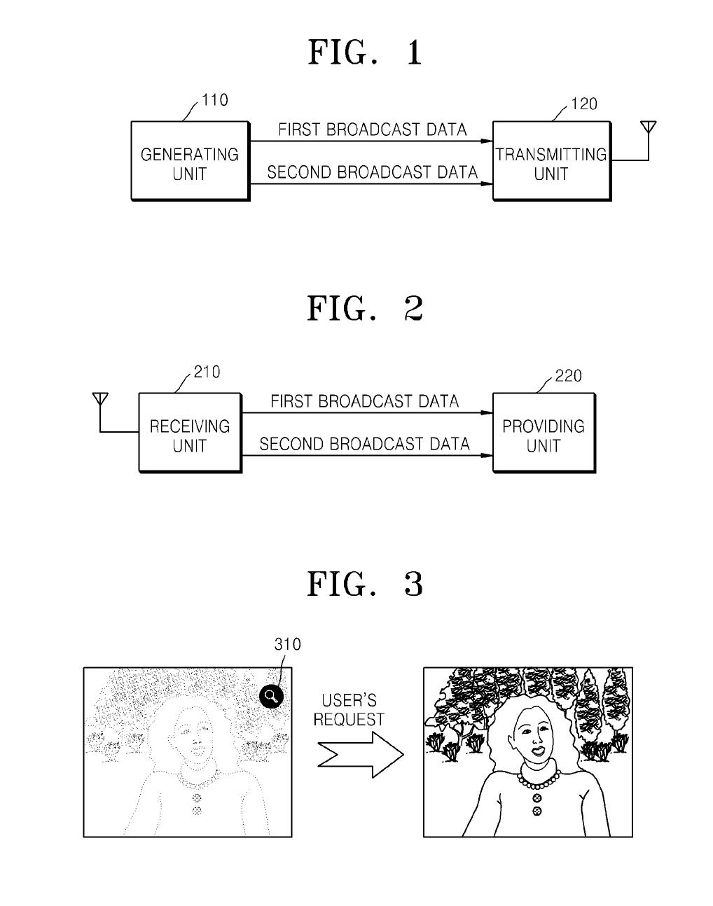

FIG. 1 is a block diagram of an apparatus for transmitting digital broadcasting according to an embodiment. Referring to FIG. 1, the apparatus for transmitting digital broadcasting includes a generating unit 110 and a transmitting unit 120.

The generating unit 110 generates main broadcast data and supplemental broadcast data, wherein the main broadcast data may independently provide a basic broadcast service and the supplemental broadcast data may provide an extended broadcast service in combination with the main broadcast data.

The basic broadcast service is a general broadcast service and may include not only a 1280×720p HD TV service but also an arbitrary broadcast service, which may be received by a conventional digital broadcasting receiver, such as a standard definition (SD) TV service or a 1920×1080i high definition (HD) TV service.

The extended broadcast service is a service that provides an extended function compared with the basic broadcast service. For example, a high-quality TV service having improved image quality than that of the basic broadcast service, a 3D TV service, a five senses TV service, or an interactive broadcast service may be provided as the extended broadcast service.

Accordingly, the supplemental broadcast data may include image quality improvement data, 3D image data, five senses data, or interactive broadcast data. In addition, the extended broadcast service includes all services provided by using information of the basic broadcast service.

According to an embodiment, all data for the extended broadcast service is not transmitted separately from the main broadcast data in order to transmit the extended broadcast service and instead, only supplemental broadcast data, which may provide the extended broadcast service in combination with the main broadcast data, is generated and transmitted so that a transmission bandwidth may be reduced.

For example, when the 3D TV service is to be provided, the entire data for the 3D TV service is not required to be separately transmitted in addition to the main broadcast data for a conventional 2D TV service. Instead, only additional 3D image information for the 2D TV service provided by the main broadcast data may be transmitted as the supplemental broadcast data. As another example, when an ultra definition (UD) TV service is to be provided, only additional image quality improvement data for the main broadcast data for conventional HD TV service may be transmitted as the supplemental broadcast data.

According to the present embodiment, as a conventional digital broadcasting receiver, which does not support the extended broadcast service, only receives the main broadcast data, backward compatibility may be provided so as to provide the basic broadcast service without being affected by the supplemental broadcast data.

The generating unit 110 generates the main broadcast data and the supplemental broadcast data each in a different manner so as to maintain backward compatibility and to increase transmission capability. For example, the main broadcast data is generated by using an encoding method supported by a general digital broadcasting receiver and the supplemental broadcast data is generated by using an improved encoding method so that a transmission band may be reduced.

In an advanced television standards committee (ATSC) system, when an image service, for example, the 1280×720p HD TV service or SD TV service, having a lower band than a general 1920×1080i HD TV service is provided as the basic broadcast service, image quality may be degraded. In particular, image quality gets worse in contents with large amounts of movement such as sport games. In this case, image quality improvement data is transmitted as the supplemental broadcast data so as to compensate for image quality. Here, the image quality improvement data is encoded by using an encoding method that is improved compared with a conventional MPEG-2 and thus an image may be provided having the same level of image quality and in a reduced band compared with the conventional 1920×1080i HD TV service.

The transmitting unit 120 transmits the main broadcast data and the supplemental broadcast data each in a different manner. That is, the transmitting unit 120 transmits the main broadcast data by using a first method and transmits the supplemental broadcast data by using a second method.

The transmitting unit 120 may transmit the main broadcast data and the supplemental broadcast data each through a different program. That is, the transmitting unit 120 transmits the main broadcast data through a first program and transmits the supplemental broadcast data through a second program. Here, the program is a group of data constituting one service. For example, users may view a service such as a drama by using information about audio packets, information about video packets, and other information included in one program map table (PMT).

In general, one program corresponds to one channel. However, the first program represents a channel corresponding to the basic broadcast service, and the first program and the second program may be combined to represent a channel corresponding to the extended broadcast service. That is, two programs may correspond to one channel. The basic broadcast service and the extended broadcast service may be each regarded as a different channel or the same channel.

The transmitting unit 120 may selectively transmit the supplemental broadcast data. For example, when a high-quality TV service exists, the image quality improvement data is transmitted as the supplemental broadcast data. When 3D TV service information exists, 3D image data is transmitted as the supplemental broadcast data. When the extended broadcast service does not exist, only the main broadcast data may be transmitted.

The transmitting unit 120 may transmit a plurality of each different supplemental broadcast data with respect to a single main broadcast data. For example, the high-quality TV service, the 3D TV service, the five senses TV service, and the interactive broadcast service may be simultaneously provided as the extended broadcast service for one basic broadcast service.

The transmitting unit 120 may selectively transmit the supplemental broadcast data according to a predetermined condition. The predetermined condition may include the degree of image quality degradation in the basic broadcast service, contents type of the basic broadcast service, contents details of the basic broadcast service, interactive broadcasting of the basic broadcast service, or the like.

For example, in home shopping contents, which need interaction with viewers through the basic broadcast service, interactive broadcast data may be transmitted as the supplemental broadcast data. When contents having serious quality degradation or contents which particularly need to be of high quality are transmitted, the image quality improvement data may be transmitted as the supplemental broadcast data. The contents having serious quality degradation include contents having texts or fine patterns in an image or contents with large amounts of movement such as sport games or action movies. In a single content, whether to transmit the supplemental broadcast data, a type of the supplemental broadcast data, an amount of the supplemental broadcast data, or a method of generating or transmitting the supplemental broadcast data may be changed according to scenes. For example, the image quality improvement data may be transmitted only at a part where serious quality degradation occurs, and different encoding methods may be used for the image quality improvement data at a scene with large amounts of movement and at a still scene.

The transmitting unit 120 transmits signaling data for the supplemental broadcast data and thus may allow a reception side to provide the extended broadcast service based on the signaling data.

The signaling data may include information indicating the existence of the supplemental broadcast data, the type of the supplemental broadcast data, a program identifier of the supplemental broadcast data, a method of generating or transmitting the supplemental broadcast data, parameter information about the method of generating or transmitting the supplemental broadcast data, matching information for connecting the main broadcast data to the supplemental broadcast data, synchronization data for synchronizing the main broadcast data with the supplemental broadcast data, and the like.

The transmitting unit 120 may transmit signaling data through program specific information (PSI) of an MPEG-2 transport stream (TS). In this case, program numbers in a program association table (PAT) may be used to signal each service and ES_Descriptor in the PMT may be used as signaling information. Also, synchronization data for being synchronizing with a main program is continuously transmitted and thus may be transmitted by being included in an audio packet or a video packet of the supplemental broadcast data, or a separate series of packets. For example, a time stamp included in an MPEG2 packetized elementary stream (MPEG2-PES) may be extended and used.

The transmitting unit 120 may transmit signaling data by using a master guide table (MGT), a terrestrial virtual channel table (TVCT), or a cable virtual channel table (CVCT) of a program and system information protocol (PSIP) of the ATSC system. In addition, a signaling method of a corresponding standard may be used according to a broadcasting standard such as DVB or ISDB-T. According to an embodiment, a part of signaling data such as synchronization data may be included in a stream of the supplemental broadcast data.

The transmitting unit 120 transmits signaling data for the supplemental broadcast data separately from signaling data for the main broadcast data so that a conventional digital broadcasting receiver which does not support the extended broadcast service may provide the basic broadcast service based only on the signaling data for the main broadcast data regardless of the signaling data for the supplemental broadcast data.

The transmitting unit 120 may transmit the main broadcast data through a TS and the supplemental broadcast data through an unused area of the TS. For example, the transmitting unit 120 may transmit the main broadcast data through the MPEG-2 TS and the supplemental broadcast data through private data bytes in an adaptation field of a MPEG-2 header. Alternatively, the transmitting unit 120 may transmit the supplemental broadcast data by using a packet ID (PID) that is not used by the main broadcast data or other broadcast data.

In this case, signaling may be performed by using a signaling method provided from a main stream or by defining an independent signaling method in the non-used area. The signaling method provided from the main stream may be reused for the independent signaling method.

The transmitting unit 120 may use another transmission method according to the supplemental broadcast data. For example, when an amount of the supplemental broadcast data is small, the supplemental broadcast data is transmitted through private data bytes and when an amount of the supplemental broadcast data is large, the supplemental broadcast data may be transmitted through another program.

The transmitting unit 120 transmits the main broadcast data and the supplemental broadcast data each in a different manner. In this regard, the main broadcast data is transmitted by using a method supported by a conventional digital broadcasting receiver so as to maintain backward compatibility and the supplemental broadcast data is transmitted by using a new method so as to increase transmission efficiency.

FIG. 2 is a block diagram of an apparatus for receiving digital broadcasting, according to an embodiment. Referring to FIG. 2, the apparatus for receiving digital broadcasting, includes a receiving unit 210 and a providing unit 220.

The receiving unit 210 receives main broadcast data and supplemental broadcast data each in a different manner. That is, the receiving unit 210 receives the main broadcast data through a first method and receives the supplemental broadcast data through a second method.

The receiving unit 210 may receive the main broadcast data and the supplemental broadcast data each through a different program. That is, the receiving unit 210 receives the main broadcast data through a first program and receives the supplemental broadcast data through a second program.

The receiving unit 210 may receive the main broadcast data through a TS and the supplemental broadcast data through an area of the TS that is not used.

According to embodiments, the supplemental broadcast data may be selectively transmitted. Thus, the receiving unit 210 determines the existence of the supplemental broadcast data and then may receive the supplemental broadcast data only when the supplemental broadcast data exists. According to an embodiment, the receiving unit 210 may receive signaling data and may determine the existence of the supplemental broadcast data based on the signaling data.

The providing unit 220 may provide the basic broadcast service based on the main broadcast data and may provide the extended broadcast service based on the main broadcast data and the supplemental broadcast data. The providing unit 220 may provide the extended broadcast service when the supplemental broadcast data exists, and the basic broadcast service when the supplemental broadcast data does not exist.

When the main broadcast data and the supplemental broadcast data are generated each in a different manner from the generating unit 110, the providing unit 220 may provide an extended broadcast service by processing the main broadcast data and the supplemental broadcast data each in a different manner. For example, when the main broadcast data and the supplemental broadcast data are encoded by using different encoding methods in the generating unit 110, the providing unit 220 may decode the main broadcast data and supplemental broadcast data by using each corresponding decoding method.

That is, a digital broadcasting receiver according to an embodiment may use a plurality of decoding methods that are each different for one service. For example, a plurality of decoding methods that are each different may be used for providing a video.

The providing unit 220 may provide the extended broadcast service by using signaling data. That is, the extended broadcast service may be provided by using data indicating the type of the supplemental broadcast data, an identifier of the supplemental broadcast data, a method of generating or transmitting the supplemental broadcast data, or synchronization data of the supplemental broadcast data included in the signaling data.

According to an embodiment, when the supplemental broadcast data exists, the extended broadcast service may be always provided or the extended broadcast service may be provided according to a predetermined condition. The predetermined condition may include the type of the supplemental broadcast data, a broadcasting receiving state, the type of power supply, user settings, or user selections.

For example, if a digital broadcasting receiver is operated by using a battery, only the basic broadcast service may be provided and if a digital broadcasting receiver is operated by using alternating current (AC) power, the extended broadcast service may be provided. As another example, as shown in FIG. 3, when the supplemental broadcast data exists, a user may be informed that the extended broadcast service may be provided through an icon 310 on a screen and when a user requests the extended broadcast service, the extended broadcast service may be provided. As another example, a high-quality TV service from among the extended broadcast services is always and automatically provided and a 3D TV service may be provided only when a user requests it. When the transfer between the basic broadcast service and the extended broadcast service is automatically performed, a user may recognize them as the same channel. In the transfer between the extended broadcast service and the other extended broadcast service, a user may recognize them as the same channel.

When the basic broadcast service is to be provided, signaling data for the supplemental broadcast data and the supplemental broadcast data may not be needed. Accordingly, a conventional digital broadcasting receiver which does not support the extended broadcast service may provide the basic broadcast service according to a conventional method regardless of signaling data for the supplemental broadcast data and the supplemental broadcast data.

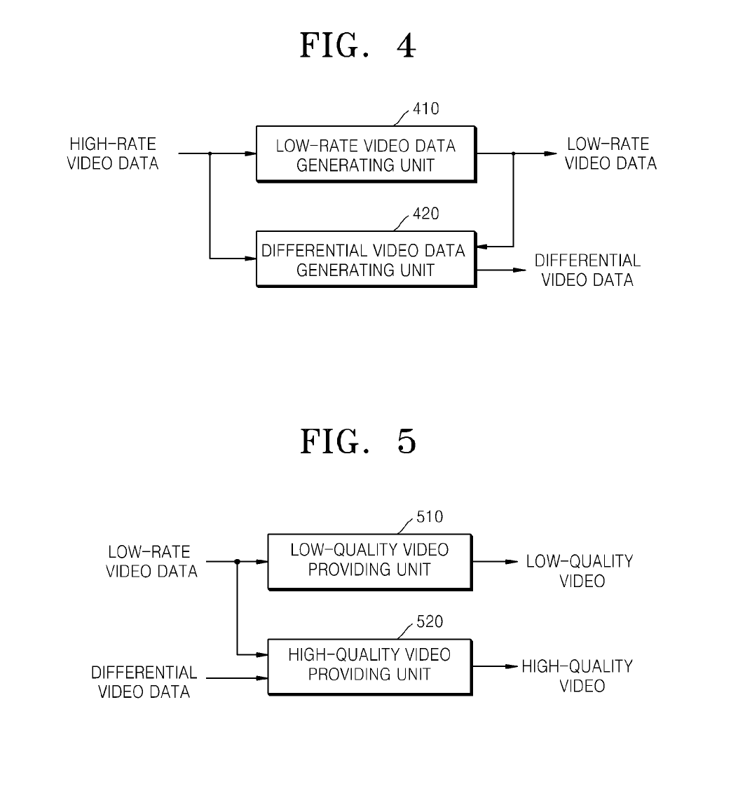

Hereinafter, a method of providing high-quality TV service will be described in detail with reference to FIGS. 4 through 7.

FIG. 4 is a block diagram illustrating a method of generating image quality improvement data for a high-quality TV service, according to an embodiment.

Referring to FIG. 4, a low-rate video data generating unit 410 generates low-rate video data having a low data rate by converting high-rate video data having a high data rate and a differential video data generating unit 420 generates differential video data representing a difference between the video represented by the high-rate video data and the video represented by the low-rate video data.

The high-rate video data is for video having improved quality than video of the low-rate video data. Here, the quality may include various indicators such as image quality, resolution, frame rate, and the like.

The generating unit 110 of FIG. 1 generates the main broadcast data by using the low-rate video data, and generates the supplemental broadcast data, which is the image quality improvement data, by using the differential video data. The low-rate video data generating unit 410 and the differential video data generating unit 420 may be included in the generating unit 110 or may be disposed outside the generating unit 110.

FIG. 5 is a block diagram illustrating a method of providing a high-quality TV service, according to an embodiment.

Referring to FIG. 5, a low-quality video providing unit 510 provides low-quality video based on the low-rate video data included in the main broadcast data. A high-quality video providing unit 520 provides high-quality video based on the low-rate video data included in the main broadcast data and the differential video data included in the supplemental broadcast data.

The low-quality video providing unit 510 may not be included or may be included in the high-quality video providing unit 520. The low-quality video providing unit 510 and the high-quality video providing unit 520 may be included in the providing unit 220 of FIG. 2. Also, as described above, the low-quality video providing unit 510 and the high-quality video providing unit 520 may selectively provide low-quality video or high-quality video according to a predetermined condition.

A conventional digital broadcasting receiver which may only provide the basic broadcast service may provide low-quality video based on the low-rate video data included in the main broadcast data regardless of the supplemental broadcast data.

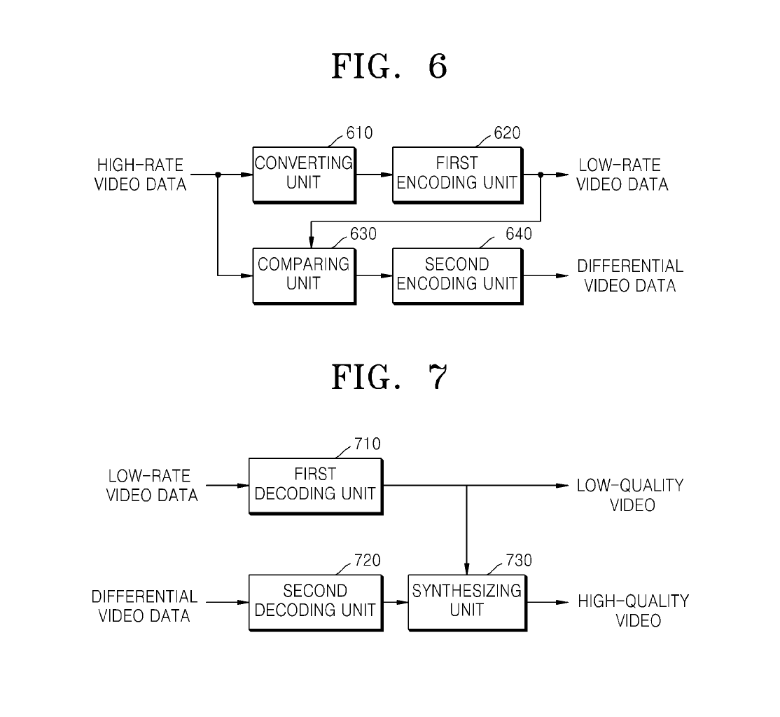

FIG. 6 is a block diagram illustrating a method of generating image quality improvement data for a high-quality TV service, according to another embodiment.

Referring to FIG. 6, a converting unit 610 reduces a data rate of the high-rate video data so as to generate low-rate data and a first encoding unit 620 encodes the low-rate data by using a first encoding method so as to generate low-rate video data. Here, the converting unit 610 may reduce the data rate by reducing the video quality, that is, image quality, resolution, frame rate, or the like. The video quality may be further reduced due to the first encoding unit 620 and, according to embodiments, the converting unit 610 may be omitted.

A comparing unit 630 compares high-quality video of the high-rate video data with low-quality video of the low-rate video data and extracts a difference. A second encoding unit 640 encodes the difference by using a second encoding method so as to generate the differential video data.

The generating unit 110 of FIG. 1 generates the main broadcast data by using the low-rate video data and generates the supplemental broadcast data, which is the image quality improvement data, by using the differential video data. The converting unit 610, the first encoding unit 620, the comparing unit 630, and the second encoding unit 640 may be included in the generating unit 110 or may be disposed outside the generating unit 110.

According to an embodiment, the first encoding method is a method, such as an MPEG-2 compression method, supported by a conventional digital broadcasting receiver so as to maintain backward compatibility and the second encoding method may increase transmission efficiency by using an improved encoding method such as H.264 or a new encoding method optimized in the differential video data. That is, the apparatus for transmitting digital broadcasting according to the embodiment uses encoding methods that are different from each other for one video so that backward compatibility may be maintained and high-quality video may be transmitted efficiently.

FIG. 7 is a block diagram illustrating a method of providing a high-quality TV service, according to another embodiment.

Referring to FIG. 7, a first decoding unit 710 decodes the low-rate video data included in the main broadcast data by using a first decoding method and thus provides low-quality video. A second decoding unit 720 decodes the differential video data included in the supplemental broadcast data by using a second decoding method and a synthesizing unit 730 synthesizes the decoded differential video data with the low-quality video and provides high-quality video. That is, the apparatus for receiving digital broadcasting may use decoding methods that are different from each other to provide one video. The first decoding unit 710, the second decoding unit 720, and the synthesizing unit 730 may be included in the providing unit 220 of FIG. 2.

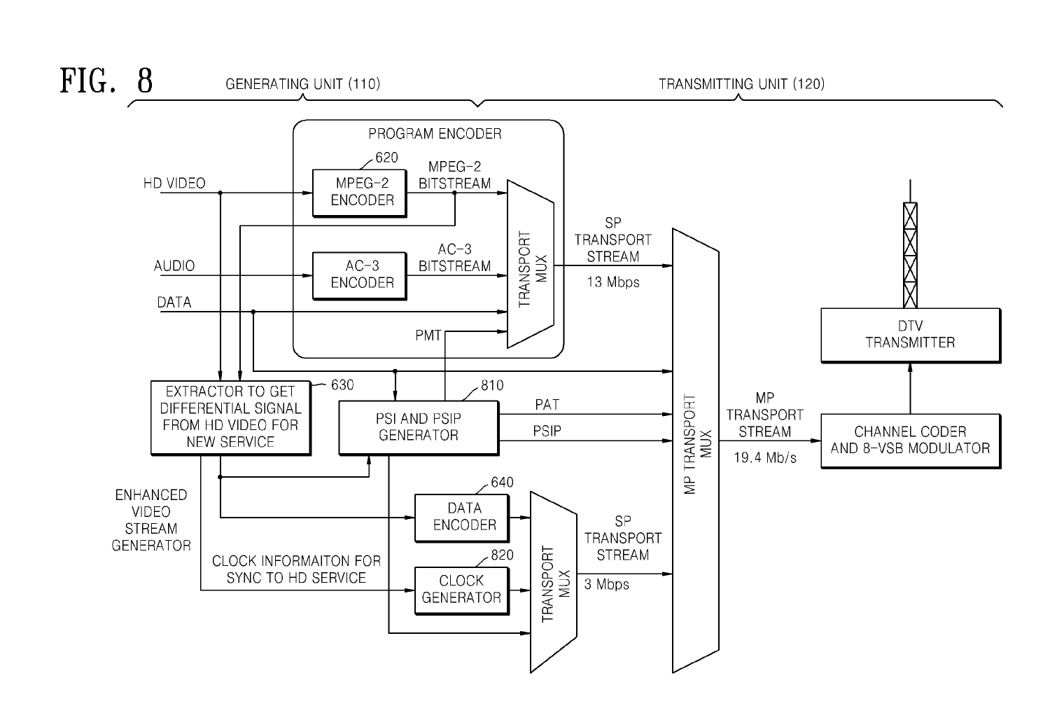

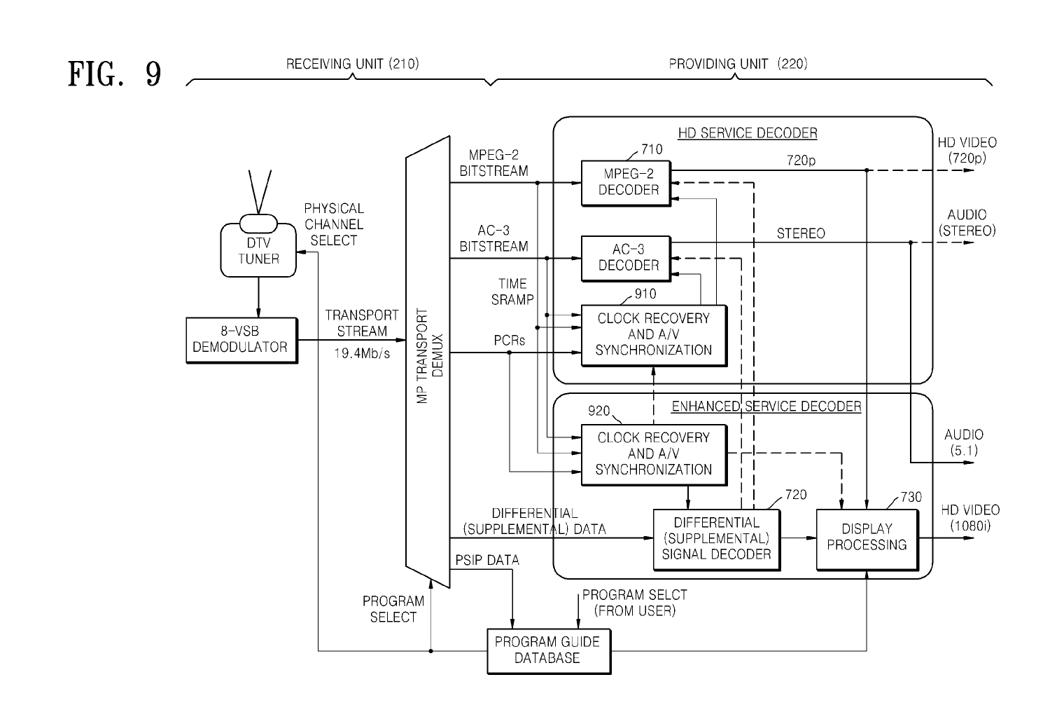

FIG. 8 illustrates an apparatus for transmitting digital broadcasting, according to an embodiment, and FIG. 9 illustrates an apparatus for receiving digital broadcasting, according to an embodiment.

Referring to FIG. 8, a PSI and PSIP generator 810 generates signaling data and a clock generator 820 generates clock data for synchronizing the main broadcast data with the supplemental broadcast data when the extended broadcast service is constituted by using the basic broadcast service. As described above, such synchronization data may be included in a stream of the supplemental broadcast data or may be included in the PSI or PSIP.

Referring to FIG. 9, clock recovery and A/V synchronizations 910 and 920 correct an output time of the basic broadcast service and the extended broadcast service or adjusts accurately an output point by using the clock data.

The other elements in FIGS. 8 and 9 are described above with reference to FIGS. 1 through 7. In this regard, the detailed descriptions of technologies and structures may be omitted so as not to hinder clear understanding of the present embodiment.

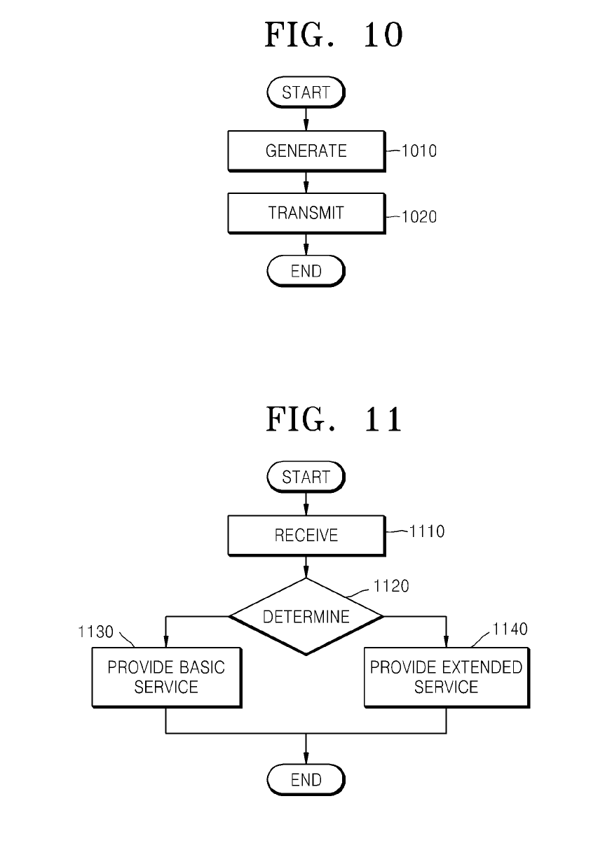

FIG. 10 is a flowchart illustrating a method of transmitting digital broadcasting according to an embodiment.

The method of transmitting digital broadcasting, according to the current embodiment, includes generating main broadcast data and supplemental broadcast data in operation 1010 and transmitting the main broadcast data and the supplemental broadcast data by using methods that are different from each other in operation 1020.

FIG. 11 is a flowchart illustrating a method of receiving digital broadcasting according to an embodiment.

The method of receiving digital broadcasting according to the current embodiment includes receiving main broadcast data by using a first method in operation 1110, determining the existence of supplemental broadcast data that matches the main broadcast data in operation 1120, providing basic broadcast service based on the main broadcast data when the supplemental broadcast data does not exist in operation 1130, and receiving the supplemental broadcast data by using a second method when the supplemental broadcast data exists and providing the extended broadcast service based on the main broadcast data and the supplemental broadcast data in operation 1140.

The aspects of the exemplary embodiments can also be embodied as computer readable codes on a non-transitory computer readable recording medium. Examples of the non-transitory computer readable recording medium include magnetic storage media and optical recording media.

While the aspects of the inventive concept have been particularly shown and described with reference to exemplary embodiments thereof, it will be understood by those of ordinary skill in the art that various changes in form and details may be made therein without departing from the spirit and scope of the inventive concept as defined by the following claims.

What is claimed is:

1. A method of transmitting digital broadcasting, the method comprising:
generating main broadcast data and supplemental broadcast data, wherein the main broadcast data is able to independently provide a basic broadcast service and the supplemental broadcast data is able to provide an extended broadcast service in combination with the main broadcast data; and
transmitting the main broadcast data and the supplemental broadcast data by using methods that are different from each other.

2. The method of claim 1, wherein the supplemental broadcast data comprises at least one from the group consisting of image quality improvement data, 3D image data, five senses data, and interactive broadcast data.

3. The method of claim 1, wherein in the transmitting, the main broadcast data and the supplemental broadcast data are transmitted through programs that are different from each other.

4. The method of claim 1, wherein the transmitting comprises:
transmitting the main broadcast data through a transport stream (TS); and
transmitting the supplemental broadcast data through an unused area of the TS.

5. The method of claim 4, wherein the TS comprises an MPEG-2 TS and the unused area of the TS comprises a private data area of an MPEG-2 header.

6. The method of claim 1, wherein in the generating of the main broadcast data and the supplemental broadcast data, the main broadcast data and the supplemental broadcast data are generated by using encoding methods that are different from each other.

7. The method of claim 1, wherein the generating of the main broadcast data and the supplemental broadcast data comprises:
generating the main broadcast data by using low-rate video data converted from high-rate video data; and
generating the supplemental broadcast data by using differential video data representing a difference in video between the high-rate video data and the low-rate video data.

8. The method of claim 7, wherein the low-rate video data and the differential video data are generated by using encoding methods that are different from each other.

9. The method of claim 1, further comprising transmitting signaling data for the supplemental broadcast data.

10. The method of claim 9, wherein the signaling data comprises at least one of the group consisting of information indicating an existence of the supplemental broadcast data, a type of the supplemental broadcast data, an identifier of the supplemental broadcast data, a method of generating the supplemental broadcast data, a method of transmitting the supplemental broadcast data, parameter information about the method of generating or transmitting the supplemental broadcast data, and synchronization data for synchronizing the main broadcast data with the supplemental broadcast data.

11. The method of claim 9, wherein in the transmitting of the signaling data, the signaling data is transmitted by using program specific information (PSI) or a program and system information protocol (PSIP).

12. The method of claim 10, wherein the transmitting of the signaling data comprises:
generating the synchronization data in connection with a time of the main broadcast data; and
transmitting the synchronization data by being included in an audio packet or a video packet of the supplemental broadcast data, or a series of packets.

13. A method of receiving digital broadcasting, the method comprising:
receiving main broadcast data by using a first method;
determining existence of supplemental broadcast data that is able to provide an extended broadcast service in combination with the main broadcast data;
providing a basic broadcast service based on the main broadcast data when the supplemental broadcast data does not exist; and
receiving the supplemental broadcast data by using a second method when the supplemental broadcast data exists and providing the extended broadcast service based on the main broadcast data and the supplemental broadcast data.

14. The method of claim 13, wherein the first method and the second method comprise a method of receiving data through programs that are different from each other.

15. The method of claim 13, wherein in the first method, data is received through a transport stream (TS) and in the second method, data is received through an unused area of the TS.

16. The method of claim 13, wherein the main broadcast data and the supplemental broadcast data are generated by using encoding methods that are different from each other.

17. The method of claim 13, wherein the main broadcast data comprises low-rate video data representing low-quality video, the supplemental broadcast data comprises differential video data representing a difference between high-quality video and the low-quality video, and the providing of the extended broadcast service comprises providing the high-quality video based on the low-rate video data and the differential video data.

18. The method of claim 13, further comprising receiving signaling data for the supplemental broadcast data.

19. The method of claim 18, wherein in the determining of the existence of the supplemental broadcast data, the existence of the supplemental broadcast data is determined based on the signaling data.

20. The method of claim 18, wherein in the providing of the extended broadcast service, the extended broadcast service is provided by using the signaling data.

21. An apparatus for transmitting digital broadcasting, the apparatus comprising:
a generating unit which generates main broadcast data and supplemental broadcast data, wherein the main broadcast data is able to independently provide a basic broadcast service and the supplemental broadcast data is able to provide an extended broadcast service in combination with the main broadcast data; and
a transmitting unit which transmits the main broadcast data and the supplemental broadcast data by using methods that are different from each other.

22. The apparatus of claim 21, wherein the transmitting unit transmits the main broadcast data and the supplemental broadcast data through programs that are different from each other.

23. The apparatus of claim 21, wherein the transmitting unit transmits the main broadcast data through a transport stream (TS) and the supplemental broadcast data through an unused area of the TS.

24. The apparatus of claim 21, wherein the generating unit generates the main broadcast data and the supplemental broadcast data by using encoding methods that are different from each other.

25. The apparatus of claim 21, wherein the generating unit generates the main broadcast data by using low-rate video data converted from high-rate video data and the supplemental broadcast data by using differential video data representing a difference in video between the high-rate video data and the low-rate video data.

26. An apparatus for receiving digital broadcasting, the apparatus comprising:
a receiving unit which receives main broadcast data by using a first method, determining the existence of supplemental broadcast data that is able to provide an extended broadcast service in combination with the main broadcast data, and which receives the supplemental broadcast data by using a second method when the supplemental broadcast data exists; and
a providing unit which provides a basic broadcast service based on the main broadcast data when the supplemental broadcast data does not exist and which provides the extended broadcast service based on the main broadcast data and the supplemental broadcast data when the supplemental broadcast data exists.

27. The apparatus of claim 26, wherein the first method and the second method comprise a method of receiving data through programs that are different from each other.

28. The apparatus of claim 26, wherein in the first method, data is received through a transport stream (TS) and in the second method, data is received through an unused area of the TS.

29. The apparatus of claim 26, wherein the main broadcast data and the supplemental broadcast data are generated by using encoding methods that are different from each other.

30. The apparatus of claim 26, wherein the main broadcast data comprises low-rate video data representing low-quality video, the supplemental broadcast data comprises differential video data representing a difference between high-quality video and the low-quality video, and the providing unit provides the high-quality video based on the low-rate video data and the differential video data.

31. A non-transitory computer readable recording medium having embodied thereon a computer program for executing the method of claim 1.

32. A non-transitory computer readable recording medium having embodied thereon a computer program for executing the method of claim 13.

33. A method of transmitting digital broadcasting, the method comprising:
generating main broadcast data and supplemental broadcast data, wherein the main broadcast data provides a basic broadcast service and the supplemental broadcast data provides an extended broadcast service in combination with the main broadcast data; and
transmitting the main broadcast data and the supplemental broadcast data through a transport stream (TS) by using different methods.

34. The method of claim 33, wherein the main broadcast data is transmitted through a first portion of the TS; and the supplemental broadcast data is transmitted through a second portion of the TS different from the first portion of the TS.

35. The method of claim 34, wherein the TS comprises an MPEG-2 TS and the second portion of the TS comprises a private data area of an MPEG-2 header of the TS.

36. The method of claim 33, wherein in the generating of the main broadcast data and the supplemental broadcast data, the main broadcast data and the supplemental broadcast data are generated by using encoding methods that are different from each other.
